(19) United States
(12) Patent Application Publication
(10) Pub. No.: US 2009/0322689 A1
(43) Pub. Date: Dec. 31, 2009

(54) TOUCH INPUT ACROSS TOUCH-SENSITIVE DISPLAY DEVICES

(76) Inventors: Wah Yiu Kwong, Beaverton, OR (US); James M. Okuley, Portland, OR (US)

Correspondence Address: INTEL CORPORATION;c/o CPA Global, P.O. BOX 52050, MINNEAPOLIS, MN, 55402, US

(21) Appl. No.: 12/165,605

(22) Filed: Jun. 30, 2008

(51) Int. Cl. G06F 3/041

(52) U.S. Cl. 345/173

(57) ABSTRACT

For one disclosed embodiment, touch input may be detected over a surface for a first touch-sensitive display device and over a surface for a second touch-sensitive display device. An operation may be performed across the first and second touch-sensitive display devices based at least in part on detected touch input having a path that traverses over the surface for the first touch-sensitive display device and over the surface for the second touch-sensitive display device. Other embodiments are also disclosed.

### FIELD

Embodiments described herein generally relate to touch sensitive input.

### BRIEF DESCRIPTION OF THE DRAWINGS

Embodiments are illustrated by way of example and not limitation in the figures of the accompanying drawings, in which like references indicate similar elements and in which:

FIG. 1 illustrates, for one embodiment, an electronic device that has dual touch-sensitive display devices and support for touch input across the touch-sensitive display devices and that is in an unfolded, generally flat position;

FIG. 2 illustrates, for one embodiment, the electronic device of FIG. 1 in a partially unfolded position;

FIG. 3 illustrates, for one embodiment, the electronic device of FIG. 1 in a folded position;

FIG. 4 illustrates, for one embodiment, a block diagram of example components of a system for the electronic device of FIG. 1;

FIG. 5 illustrates, for one embodiment, an example flow diagram to perform an operation using touch input across touch-sensitive display devices;

FIG. 6 illustrates, for one embodiment, touch-sensitive display devices having a boundary portion to support touch input across touch-sensitive display devices;

FIG. 7 illustrates, for one embodiment, touch-sensitive display devices having a boundary portion to support touch input across touch-sensitive display devices;

FIG. 8 illustrates, for one embodiment, an example flow diagram to perform an operation using touch input across touch-sensitive display devices;

FIG. 9 illustrates, for one embodiment, touch-sensitive display devices and a touch sensor to support touch input across touch-sensitive display devices; and

FIG. 10 illustrates, for one embodiment, touch sensors of touch-sensitive display devices coupled in series.

The figures of the drawings are not necessarily drawn to scale.

### DETAILED DESCRIPTION

The following detailed description sets forth example embodiments of apparatuses, methods, and systems relating to touch input across touch-sensitive display devices. Features, such as structure(s), function(s), and/or characteristic(s) for example, are described with reference to one embodiment as a matter of convenience; various embodiments may be implemented with any suitable one or more described features.

Electronic Device with Dual Touch-Sensitive Display Devices

FIG. 1 illustrates, for one embodiment, an electronic device 100 having dual touch-sensitive display devices 110 and 120. Touch-sensitive display device 110 has a surface 111 over which touch may be detected, and touch-sensitive display device 120 has a surface 121 over which touch may be detected. Electronic device 100 has support for touch input across touch-sensitive display devices 110 and 120. Electronic device 100 for one embodiment may therefore allow a user to perform any suitable operation across touch-sensitive display devices 110 and 120 with touch input having a path over both surfaces 111 and 121.

As one example, as illustrated in FIG. 1, a user may perform a drag operation to move a digital object 130, such as an icon for example, displayed by touch-sensitive display device 110 at an initial location on or through surface 111 to touch-sensitive display device 120 for display at a desired location on or through surface 121. The user for one embodiment may touch over digital object 130 using the user's finger, for example, and move the user's finger over surface 111 toward surface 121 and over surface 121 to the desired location.

Although illustrated for one embodiment as being touch-sensitive to a user's finger, touch-sensitive display devices 110 and 120 for one embodiment may be touch-sensitive to any suitable one or more objects, including a user's finger, a stylus, and/or a pen for example.

By supporting touch input across touch-sensitive display devices 110 and 120, electronic device 100 for one embodiment effectively provides a larger surface over which continuous touch may be input for electronic device 100.

Electronic device 100 for one embodiment, as illustrated in FIG. 1, may comprise housing structure 140 that supports touch-sensitive display devices 110 and 120 in a clamshell configuration. Housing structure 140 for one embodiment may define an axis about which touch-sensitive display devices 110 and 120 may be at least partially rotated to allow touch-sensitive display devices 110 and 120 to be folded toward one another with at least a portion of surfaces 111 and 121 generally facing each other and to be unfolded away from one another. Housing structure 140 for one embodiment may define an axis with any suitable one or more hinges. For one embodiment where surfaces 111 and 121 are, for example, generally rectangular in shape, housing structure 140 for one embodiment may define an axis that is generally parallel to any suitable edge of each of surfaces 111 and 121. As illustrated in FIGS. 1, 2, and 3, housing structure 140 for one embodiment may define an axis that is generally parallel to a longer edge of each of surfaces 111 and 121.

Housing structure 140 for one embodiment, as illustrated in FIG. 1, may allow touch-sensitive display devices 110 and 120 to be unfolded into a generally flat position. Housing structure 140 for one embodiment may support touch-sensitive display devices 110 and 120 in this position to align surfaces 111 and 121 in a generally coplanar manner. Noting electronic device 100 supports touch input across touch-sensitive display devices 110 and 120, electronic device 100 for one embodiment may be configured to function similarly as or to emulate any suitable device having a single, larger touch-sensitive display, such as a tablet computer or an interactive table top surface for example, in this position. Housing structure 140 for one embodiment may be designed to help minimize a gap or spacing between boundaries of surfaces 111 and 121 in this position to help facilitate touch input across surfaces 111 and 121.

Housing structure 140 for one embodiment, as illustrated in FIG. 2, may allow touch-sensitive display devices 110 and 120 to be partially unfolded into any suitable position. Electronic device 100 for one embodiment may be positioned similarly as an open notebook computer by positioning touch-sensitive display device 120 as a base and positioning touch-sensitive display device 110 to project upward at a desired angle from the base. Electronic device 100 for one embodiment may be configured to function similarly as or to emulate a notebook computer in this position, for example by configuring touch-sensitive display device 110 to implement a soft or virtual keyboard when desired. Electronic device 100 for one embodiment may be partially unfolded and positioned similarly as an open book or newspaper and configured as a reading device that emulates, for example, a book and/or a newspaper.

Electronic device 100 for one embodiment may support touch input across touch-sensitive display devices 110 and 120 in one or more partially unfolded positions. As illustrated in FIG. 2, for example, a user for one embodiment may use the user's finger, for example, to touch over a digital object 230 displayed at an initial location on or through surface 111 and move the user's finger down over surface 111 toward surface 121 and over surface 121 to move digital object 230 for display at a desired location on or through surface 121.

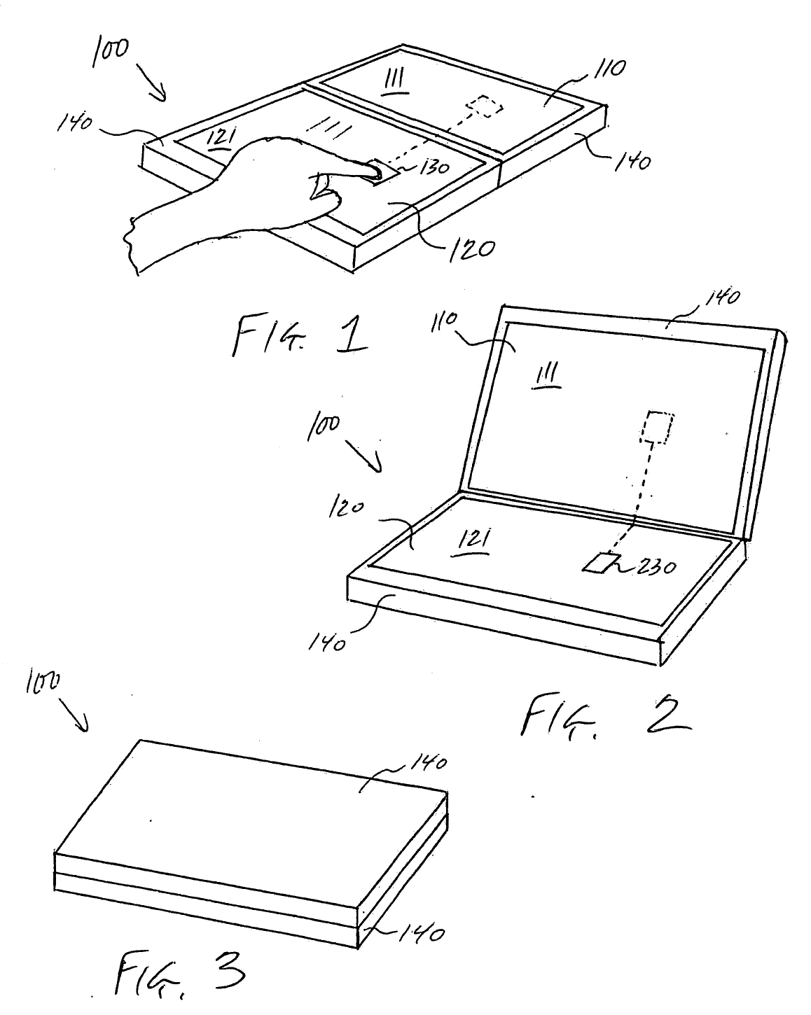

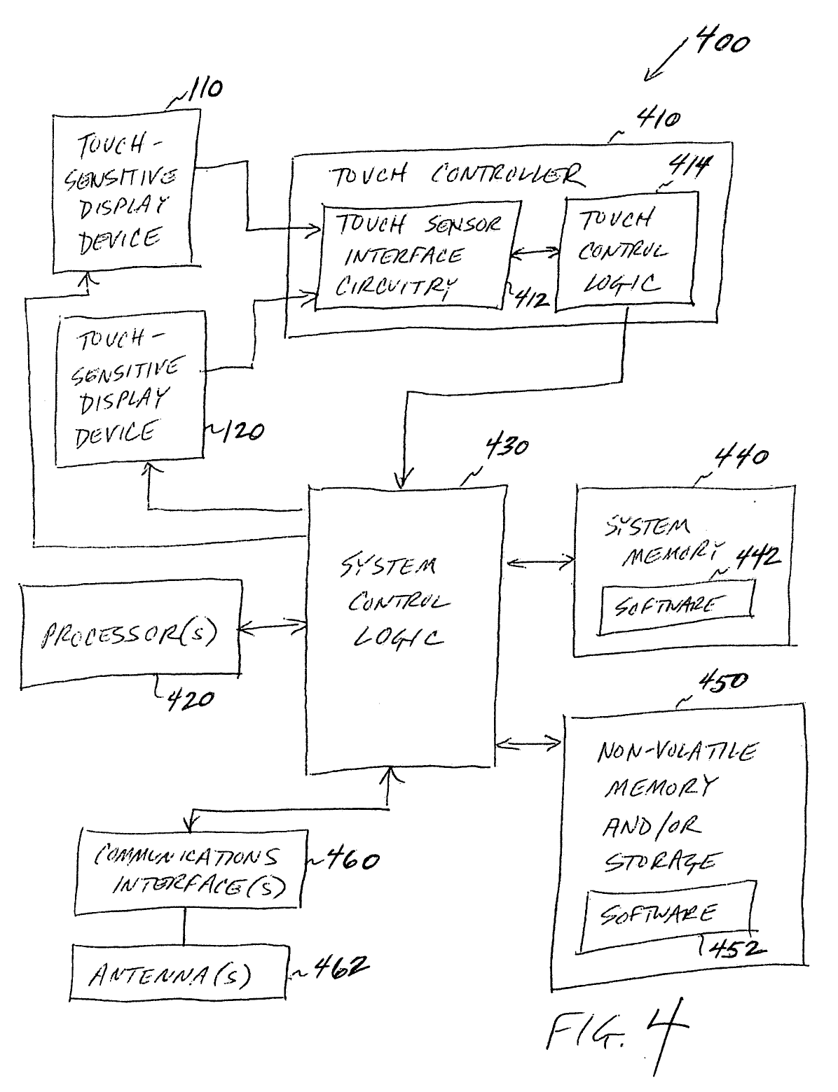

As illustrated in FIG. 3, housing structure 140 for one embodiment may allow touch-sensitive display devices 110 and 120 to be folded into a closed position with at least a portion of surfaces 111 and 121 facing each other. Folding touch-sensitive display devices 110 and 120 into the closed position for one embodiment may help protect touch-sensitive display devices 110 and 120 from scratching and/or impact. Folding touch-sensitive display devices 110 and 120 into the closed position for one embodiment may help make electronic device 100 more compact for ease of mobility and/or storage. Noting electronic device 100 may be configured to implement any suitable device having a single, larger touch-sensitive display when electronic device 100 is unfolded into a generally flat position, folding electronic device 100 for one embodiment may help provide for greater ease of mobility and/or storage relative to such a device that has a single, larger, physically integral touch-sensitive display.

Electronic device 100 may have touch-sensitive display devices 110 and 120 with surfaces 111 and 121 of any suitable size and shape. Touch-sensitive display devices 110 and 120 for one embodiment may each have surfaces 111 and 121, respectively, sized and shaped similarly as a display for a typical tablet or notebook computer to implement, for example, a large workstation with folding tablets, a notebook computer, and/or a large reading device. Touch-sensitive display devices 110 and 120 for one embodiment may each have surfaces 111 and 121, respectively, sized and shaped as a smaller display, such as that for a typical subnotebook computer or ultra-mobile personal computer (UMPC) for example, to implement, for example, a tablet computer with a single, larger touch-sensitive display when electronic device 100 is unfolded into a generally flat position, a subnotebook or notebook computer, and/or a smaller reading device. Touch-sensitive display devices 110 and 120 for one embodiment may each have surfaces 111 and 121, respectively, sized and shaped as an even smaller display, such as the size of a personal digital assistant (PDA) or cell phone for example, to implement, for example, a mobile internet device (MID) or an ultra-mobile personal computer (UMPC) with a single, larger touch-sensitive display when electronic device 100 is unfolded into a generally flat position, a folding PDA or cell phone, and/or a smaller reading device. Touch-sensitive display devices 110 and 120 for one embodiment may each have surfaces 111 and 121, respectively, sized and shaped to implement, for example, a remote control device to control, for example, any suitable audio and/or visual equipment and/or a remote computer.

Although described for one embodiment as comprising housing structure 140 that supports touch-sensitive display devices 110 and 120 in a clamshell configuration, electronic device 100 may comprise any suitable housing structure to support touch-sensitive display devices 110 and 120 in any suitable manner. Suitable housing structure for one embodiment may support touch-sensitive display devices 110 and 120 near one another in any suitable configuration to help facilitate touch input across surfaces 111 and 121. Suitable housing structure for one embodiment may support touch-sensitive display devices 110 and 120 near one another in any suitable fixed configuration.

Example System for Electronic Device

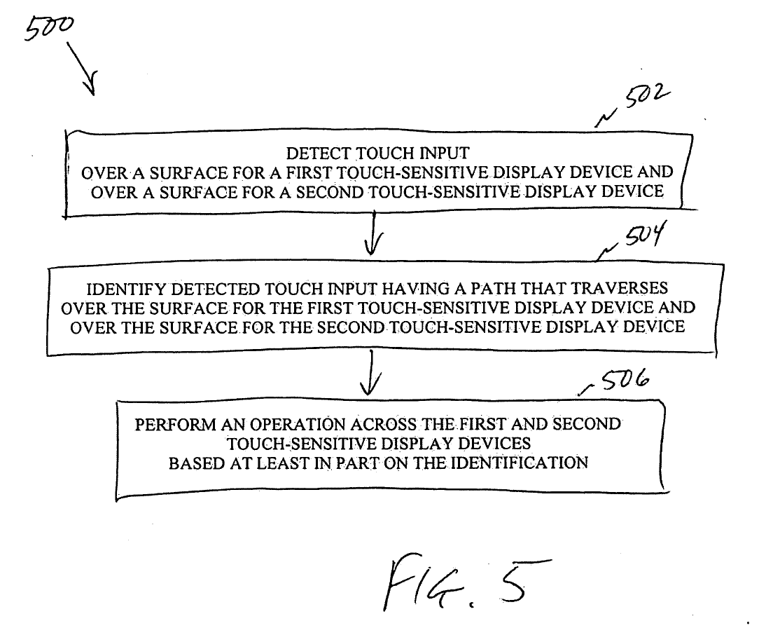

Electronic device 100 may be implemented using any suitable hardware and/or software to configure electronic device 100 as desired. FIG. 4 illustrates, for one embodiment, an example system 400 comprising touch-sensitive display devices 110 and 120, a touch controller 410, one or more processors 420, system control logic 430 coupled to at least one processor 420, system memory 440 coupled to system control logic 430, non-volatile memory and/or storage device(s) 450 coupled to system control logic 430, and one or more communications interfaces 460 coupled to system control logic 430.

Touch-sensitive display devices 110 and 120 may each be implemented using any suitable touch-sensitive technology such as, for example and without limitation, capacitive, resistive, surface acoustic wave (SAW), infrared, and optical imaging. The touch-sensitive technology used for touch-sensitive display device 110 and/or 120 for one embodiment may not require actual touching over surface 111 and/or 121, respectively, but rather may sense the presence of an object near surface 111 and/or 121, respectively. Such technology may nevertheless be considered touch-sensitive because such technology will similarly sense an object that actually touches over surface 111 and/or 121 and because surfaces 111 and 121 are likely to be actually touched when electronic device 100 is used. Touch-sensitive display device 110 and/or 120 for one embodiment may be implemented using any suitable multi-touch technology.

Touch-sensitive display devices 110 and 120 each have a display that may be implemented using any suitable display technology, such as that for a liquid crystal display (LCD) for example.

System control logic 430 for one embodiment may include any suitable interface controllers to provide for any suitable interface to at least one processor 420 and/or to any suitable device or component in communication with system control logic 430.

System control logic 430 for one embodiment may include one or more memory controllers to provide an interface to system memory 440. System memory 440 may be used to load and store data and/or instructions, for example, for system 400. System memory 440 for one embodiment may include any suitable volatile memory, such as suitable dynamic random access memory (DRAM) for example.

System control logic 430 for one embodiment may include one or more input/output (I/O) controllers to provide an interface to touch-sensitive display devices 110 and 120, touch controller 410, non-volatile memory and/or storage device(s) 450, and communications interface(s) 460.

Touch controller 410 may be coupled to help control touch input through touch-sensitive display devices 110 and 120. Touch controller 410 for one embodiment may be coupled to system control logic 430 for at least one I/O controller and/or at least one processor 420 to process touch input detected by touch controller 410 through touch-sensitive display devices 110 and 120. System control logic 430 for one embodiment may include one or more graphics controllers to provide one or more display interfaces to touch-sensitive display devices 110 and 120.

Non-volatile memory and/or storage device(s) 450 may be used to store data and/or instructions, for example. Non-volatile memory and/or storage device(s) 450 may include any suitable non-volatile memory, such as flash memory for example, and/or may include any suitable non-volatile storage device(s), such as one or more hard disk drives (HDDs), one or more compact disc (CD) drives, and/or one or more digital versatile disc (DVD) drives for example.

Communications interface(s) 460 may provide an interface for system 400 to communicate over one or more networks and/or with any other suitable device. Communications interface(s) 460 may include any suitable hardware and/or firmware. Communications interface(s) 460 for one embodiment may include, for example, a network adapter, a wireless network adapter, a telephone modem, and/or a wireless modem. For wireless communications, communications interface(s) 460 for one embodiment may use one or more antennas 462.

System control logic 430 for one embodiment may include one or more input/output (I/O) controllers to provide an interface to any suitable input/output device(s) such as, for example, an audio device to help convert sound into corresponding digital signals and/or to help convert digital signals into corresponding sound, a camera, a camcorder, a printer, and/or a scanner.

For one embodiment, at least one processor 420 may be packaged together with logic for one or more controllers of system control logic 430. For one embodiment, at least one processor 420 may be packaged together with logic for one or more controllers of system control logic 430 to form a System in Package (SiP). For one embodiment, at least one processor 420 may be integrated on the same die with logic for one or more controllers of system control logic 430. For one embodiment, at least one processor 420 may be integrated on the same die with logic for one or more controllers of system control logic 430 to form a System on Chip (SoC).

Although described for one embodiment as being used in system 400, touch controller 410 and touch-sensitive display devices 110 and 120 for other embodiments may be used in other system configurations.

Touch Controller

Touch controller 410 for one embodiment, as illustrated in FIG. 4, may include touch sensor interface circuitry 412 and touch control logic 414.

Touch sensor interface circuitry 412 may be coupled to detect touch input over surfaces 111 and 121 for touch-sensitive display devices 110 and 120, respectively, in any suitable manner. Touch sensor interface circuitry 412 may include any suitable circuitry that may depend, for example, at least in part on the touch-sensitive technology used for touch-sensitive display devices 110 and 120. Touch sensor interface circuitry 412 for one embodiment may support any suitable multi-touch technology. Touch sensor interface circuitry 412 for one embodiment may include any suitable circuitry to convert analog signals corresponding to touch input over surfaces 111 and 121 into any suitable digital touch input data. Suitable digital touch input data for one embodiment may include, for example, touch location or coordinate data.

Touch control logic 414 may be coupled to help control touch sensor interface circuitry 412 in any suitable manner to detect touch input over surfaces 111 and 121. Touch control logic 414 for one embodiment may also be coupled to output in any suitable manner digital touch input data corresponding to touch input detected by touch sensor interface circuitry 412. Touch control logic 414 may be implemented using any suitable logic, including any suitable hardware, firmware, and/or software logic, that may depend, for example, at least in part on the circuitry used for touch sensor interface circuitry 412. Touch control logic 414 for one embodiment may support any suitable multi-touch technology.

Touch control logic 414 for one embodiment, as illustrated in FIG. 4, may be coupled to output digital touch input data to system control logic 430 and/or at least one processor 420 for processing. At least one processor 420 for one embodiment may execute any suitable software to process digital touch input data output from touch control logic 414. Suitable software may include, for example, any suitable driver software and/or any suitable application software. As illustrated in FIG. 4, system memory 440 may store suitable software 442 and/or non-volatile memory and/or storage device(s) 450 may store suitable software 452 for execution by at least one processor 420 to process digital touch input data.

Touch sensor interface circuitry 412 and/or touch control logic 414 for one embodiment may generate digital touch input data corresponding to a single, larger touch input area coordinate system onto which a logical combination of at least a portion of each of surfaces 111 and 121 may be mapped. In this manner, processor(s) 420 for one embodiment may execute any suitable software responsive to touch-sensitive display devices 110 and 120 without having to account for two separate touch input area coordinate systems.

Touch control logic 414 for one embodiment may have any suitable logic to support touch input across touch-sensitive display devices 110 and 120 in any suitable manner. Touch control logic 414 for one embodiment may include any suitable logic to treat touch input detected over surface 121 as being continued from touch input detected over surface 111 and/or to treat touch input detected over surface 111 as being continued from touch input detected over surface 121.

Touch control logic 414 for one embodiment may output digital touch input data for only a brief moment in response to detection of touch input over surface 111 and/or 121. In this manner, touch control logic 414 for one embodiment may help at least one processor 420 executing software to process digital touch input data to identify lapses in and therefore help interpret touch input over surface 111 and/or 121. For one embodiment, at least one processor 420 executing software to process digital touch input data may interpret a lapse in touch input as a command, for example, to end or undo an operation initiated using substantially continuous touch input.

To help avoid introducing in the output of digital touch input data a delay that would be interpreted as a lapse in touch input when detected touch input traverses a gap between boundaries of surfaces 111 and 121, touch control logic 414 for one embodiment may include any suitable logic to output any suitable transitional touch input data when detected touch input traverses a gap between boundaries of surfaces 111 and 121. Suitable transitional touch input data for one embodiment may correspond, for example, to a last or near last location of detected touch input prior to its traversal over the gap. Touch control logic 414 for one embodiment may output transitional touch input data until touch input is again detected over surface 111 or 121 or until a predetermined amount of time passes without touch input detection. In this manner when detected touch input traverses from over one surface 111, for example, and over a gap between surfaces 111 and 121 to over the other surface 121, at least one processor 420 executing software to process digital touch input data for one embodiment may not interpret a lapse in touch input and therefore process touch input data corresponding to detected touch input over both surfaces 111 and 121 for the same operation.

Operation Across Touch-Sensitive Display Devices

FIG. 5 illustrates, for one embodiment, an example flow diagram 500 to perform an operation using touch input across touch-sensitive display devices 110 and 120.

For block 502 of FIG. 5, touch input over surfaces 111 and 121 may be detected. For one embodiment, touch sensor interface circuitry 412 may be used to detect touch input over surfaces 111 and 121.

Detected touch input having a path that traverses over surfaces 111 and 121 may be identified for block 504, and an operation across touch-sensitive display devices 110 and 120 may be performed for block 506 based at least in part on the identification. For one embodiment, as illustrated in FIG. 4, system control logic 430 and/or at least one processor 420 may interface with touch controller 410 to identify in any suitable manner detected touch input as having such a path and may interface with displays of touch-sensitive display devices 110 and 120 to perform in any suitable manner any suitable operation across touch-sensitive display devices 110 and 120 based at least in part on such detected touch input.

One suitable operation may be, for example, to drag or move a displayed digital object along a touch input path that crosses both surfaces 111 and 121. Another suitable operation may be, for example, to drag or move one or more boundaries of a displayed digital object, such as a window, picture, or document for example, in accordance with a touch input path that crosses both surfaces 111 and 121 to change the size of the digital object.

For one embodiment, touch controller 410 may help at least one processor 420 executing software to identify detected touch input having a path that traverses over both surfaces 111 and 121 by treating touch input detected over surface 121 as being continued from touch input detected over surface 111 and/or treating touch input detected over surface 111 as being continued from touch input detected over surface 121. Touch controller 410 for one embodiment may treat detected touch input in this manner by outputting transitional touch input data when detected touch input traverses a gap between surfaces 111 and 121.

Operations for blocks 502-506 may be performed in any suitable order and may overlap in time with any other suitable operation. As one example, touch input over surface 121 may be detected for block 502 and identified for block 504 as part of detected touch input having a path that traverses over surfaces 111 and 121 as an operation is being performed for block 506.

Use of Surface Boundary Portion

Touch control logic 414 of touch controller 410 for one embodiment may include any suitable logic to identify in any suitable manner when detected touch input may traverse over a gap between surfaces 111 and 121.

Touch control logic 414 for one embodiment may identify detected touch input near or at a boundary of a display for touch-sensitive display device 110 or 120 to identify that detected touch input may traverse over the gap. Touch control logic 414 for one embodiment may identify detected touch input that has traversed beyond the boundary of the display for touch-sensitive display device 110 or 120 to identify that detected touch input may traverse over the gap.

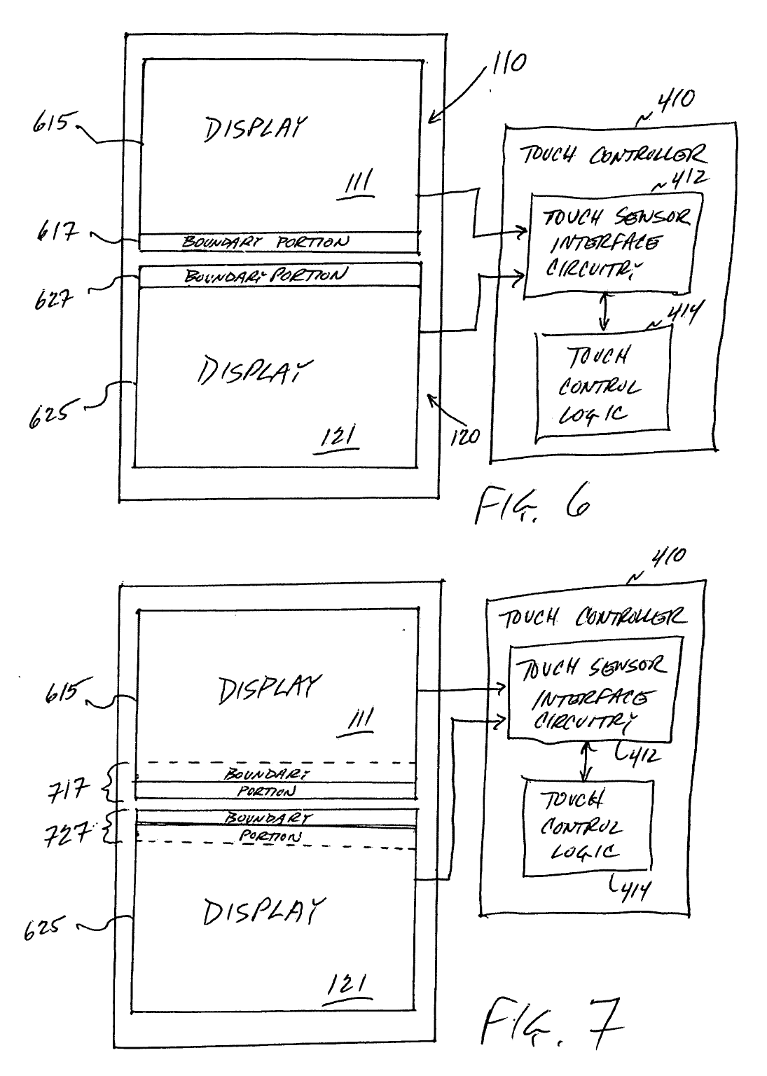

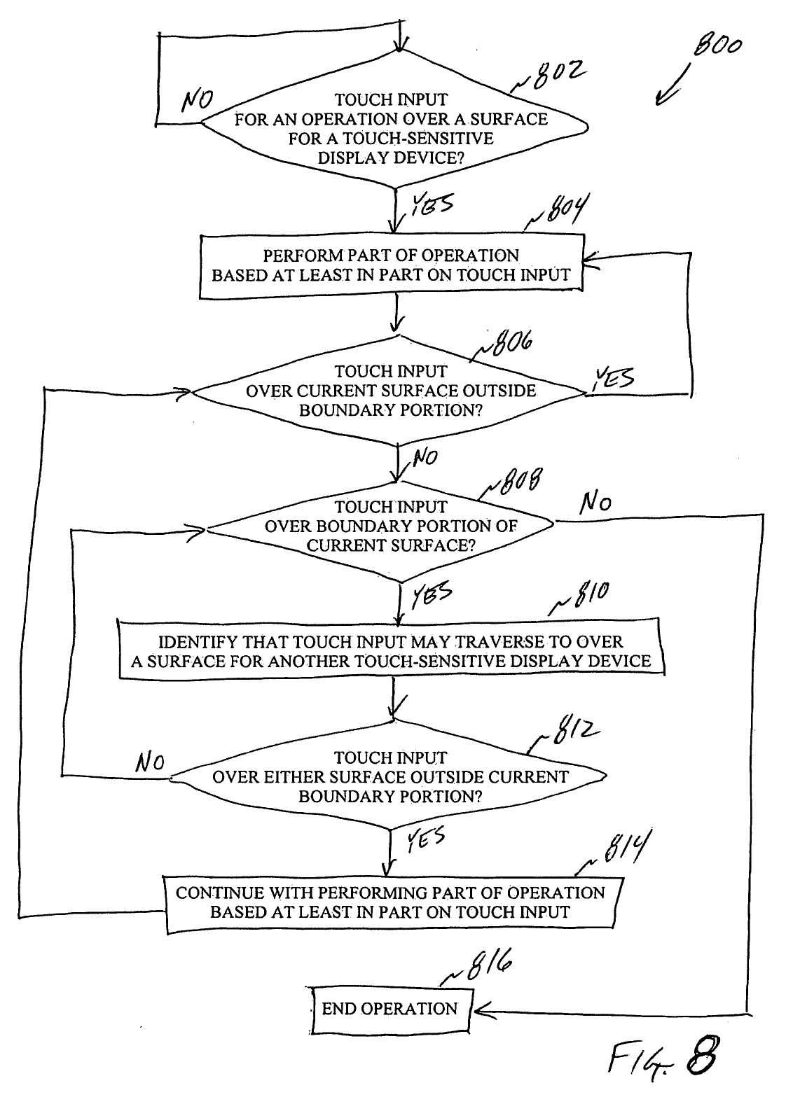

Surface 111 for one embodiment may have a boundary portion, such as, for example, a boundary portion 617 as illustrated in FIG. 6 or, for example, a boundary portion 717 as illustrated in FIG. 7. Touch control logic 414 for one embodiment may identify detected touch input traversing over or beyond the boundary portion of surface 111 to identify that detected touch input may traverse from over surface 111 to over surface 121.

Surface 111 for one embodiment may have a boundary portion of any suitable size and shape. The boundary portion for one embodiment may generally lie between a display for touch-sensitive display device 110 and surface 121 along most or substantially all direct paths for touch input from over surface 111 that overlaps the display for touch-sensitive display device 110 to over surface 121.

For one embodiment, as illustrated in FIG. 6, surface 111 may have boundary portion 617 that does not overlap a display 615 for touch-sensitive display device 110. Boundary portion 617 for one embodiment may have a height, for example, of one or two pixels. Touch control logic 414 for one embodiment may identify detected touch input over boundary portion 617 to identify detected touch input that has traversed beyond a boundary of display 615.

For one embodiment, as illustrated in FIG. 7, surface 111 may have boundary portion 717 at least a portion of which overlaps display 615. Touch control logic 414 for one embodiment may identify detected touch input over boundary portion 717 that overlaps display 615 to identify detected touch input near or at a boundary of display 615. For one embodiment, at least a portion of boundary portion 717 may not overlap display 615. Touch control logic 414 for one embodiment may identify detected touch input over boundary portion 717 that does not overlap display 615 to identify detected touch input that has traversed beyond a boundary of display 615.

Surface 121 for one embodiment may have a boundary portion, such as, for example, a boundary portion 627 as illustrated in FIG. 6 or, for example, a boundary portion 727 as illustrated in FIG. 7. Touch control logic 414 for one embodiment may identify detected touch input traversing over or beyond the boundary portion of surface 121 to identify that detected touch input may traverse from over surface 121 to over surface 111.

Surface 121 for one embodiment may have a boundary portion of any suitable size and shape. The boundary portion for one embodiment may generally lie between a display for touch-sensitive display device 120 and surface 111 along most or substantially all direct paths for touch input from over surface 121 that overlaps the display for touch-sensitive display device 120 to over surface 111.

For one embodiment, as illustrated in FIG. 6, surface 121 may have boundary portion 627 that does not overlap display 625 for touch-sensitive display device 120. Boundary portion 627 for one embodiment may have a height, for example, of one or two pixels. Touch control logic 414 for one embodiment may identify detected touch input over boundary portion 627 to identify detected touch input that has traversed beyond a boundary of display 625.

For one embodiment, as illustrated in FIG. 7, surface 121 may have boundary portion 727 at least a portion of which overlaps display 625. Touch control logic 414 for one embodiment may identify detected touch input over boundary portion 727 that overlaps display 625 to identify detected touch input near or at a boundary of display 625. For one embodiment, at least a portion of boundary portion 727 may not overlap display 625. Touch control logic 414 for one embodiment may identify detected touch input over boundary portion 727 that does not overlap display 625 to identify detected touch input that has traversed beyond a boundary of display 625.

FIG. 8 illustrates, for one embodiment, an example flow diagram 800 to perform an operation using touch input across touch-sensitive display devices 110 and 120.

For block 802 of FIG. 8, touch input for an operation may be identified over a surface for a touch-sensitive display device. For one embodiment, as illustrated in FIG. 4, system control logic 430 and/or at least one processor 420 may interface with touch controller 410 to identify in any suitable manner whether detected touch input is for an operation to be performed. Any suitable operation may be supported using touch input.

One suitable operation may be, for example, to drag or move a displayed digital object along a touch input path. For one embodiment, touch input originating from over the displayed digital object may be identified as touch input to drag the digital object.

Another suitable operation may be, for example, to drag or move one or more boundaries of a displayed digital object, such as a window, picture, or document for example, in accordance with a touch input path to change the size of the digital object. For one embodiment, touch input originating from over a boundary region of the displayed digital object may be identified as touch input to drag one or more boundaries of the digital object.

For block 804, at least part of the operation may be performed based at least in part on touch input. For one embodiment, as illustrated in FIG. 4, system control logic 430 and/or at least one processor 420 may interface with a display for a current touch-sensitive display device 110 or 120 to perform part of the operation based at least in part on touch input.

Whether touch input for the operation is detected over the current surface 111 or 121 outside the boundary portion of the current surface 111 or 121 may be identified for block 806. For one embodiment, as illustrated in FIG. 4, system control logic 430 and/or at least one processor 420 may interface with touch controller 410 to identify in any suitable manner whether touch input is detected for block 806.

For one embodiment, part of the operation may be performed for block 804 as touch input for the operation continues to be detected for block 806 over the current surface 111 or 121 outside the boundary portion of the current surface 111 or 121. As one example, a display for a current touch-sensitive display device 110 or 120 may be updated to initially highlight or lift, for example, and then move a displayed digital object along a touch input path as touch input is detected.

Whether touch input for the operation is detected over the boundary portion of the current surface 111 or 121 may be identified for block 808. For one embodiment, touch controller 410 may identify in any suitable manner whether touch input is detected for block 808.

If touch input for the operation is not detected over the current surface 111 or 121 outside the boundary portion of the current surface 111 or 121 for block 806 and if touch input is not detected over the boundary portion of the current surface 111 or 121 for block 808, then the operation may end for block 816.

If touch input is detected over the boundary portion of the current surface 111 or 121 for block 808, then touch input for the operation may be identified for block 810 that it may traverse to over a surface for another touch-sensitive display device. For one embodiment, touch controller 410 may identify for block 810 that touch input for the operation may traverse to over a surface for another touch-sensitive display device. Touch controller 410 for one embodiment for block 810 may output suitable transitional touch input data to help avoid introducing in the output of digital touch input data a delay that would be interpreted as a lapse in touch input if detected touch input traverses a gap between boundaries of surfaces 111 and 121. Suitable transitional touch input data for one embodiment may correspond, for example, to a last or near last location of detected touch input over surface 111 and/or over the display for the current touch-sensitive display device 110 or 120.

Whether touch input for the operation is detected over either surface 111 or 121 outside the current boundary portion may be identified for block 812. For one embodiment, as illustrated in FIG. 4, system control logic 430 and/or at least one processor 420 may interface with touch controller 410 to identify in any suitable manner whether touch input is detected for block 812.

If touch input for the operation is not detected over either surface 111 or 121 outside the current boundary portion for block 812 and if touch input is not detected over the current boundary portion for block 808, then the operation may end for block 816.

If touch input for the operation is not detected over either surface 111 or 121 outside the current boundary portion for block 812 and if touch input is detected over the current boundary portion for block 808, then touch input for the operation may continue to be identified for block 810 that it may traverse to over a surface for another touch-sensitive display device.

If touch input for the operation is detected over either surface 111 or 121 outside the current boundary portion for block 812, part of the operation may continue to be performed for block 814 based at least in part on touch input. For one embodiment, as illustrated in FIG. 4, system control logic 430 and/or at least one processor 420 may interface with a display for a current touch-sensitive display device 110 or 120 to perform part of the operation based at least in part on touch input.

As one example, touch input for an operation may traverse from over surface 111 outside the boundary portion of surface 111 to over the boundary portion of surface 111, then to over a gap between surfaces 111 and 121, and then to over surface 121. When touch input for the operation is detected over surface 121 for block 812, part of the operation may continue to be performed for block 814. For one embodiment, as illustrated in FIG. 4, system control logic 430 and/or at least one processor 420 may interface with the display for the new current touch-sensitive display device 120 to perform part of the operation based at least in part on touch input.

As another example, touch input for an operation may traverse from over surface 111 outside the boundary portion of surface 111 to over the boundary portion of surface 111, then to over a gap between surfaces 111 and 121, and then back to over surface 111. When touch input for the operation is detected over surface 111 for block 812, part of the operation may continue to be performed for block 814. For one embodiment, as illustrated in FIG. 4, system control logic 430 and/or at least one processor 420 may continue to interface with the display for the current touch-sensitive display device 110 to perform part of the operation based at least in part on touch input.

Touch controller 410 for one embodiment may output transitional touch input data for block 810 until touch input is again detected over surface 111 or 121 for block 812 at which time touch controller 410 may resume outputting touch input data corresponding to touch input detected over surface 111 or 121. In this manner, at least one processor 420 executing software to process digital touch input data for one embodiment may not interpret a lapse in touch input and therefore process touch input data corresponding to detected touch input over both surfaces 111 and 121 for the same operation.

For one embodiment, touch control logic 414 of touch controller 410 may logically overlap at least a portion of the boundary portions of surfaces 111 and 121 to treat at least a portion of the boundary portion of surface 111 as part of touch-sensitive display device 120 when detected touch input traverses from over surface 111 outside the boundary portion of surface 111 to over the boundary portion of surface 111. Touch control logic 414 for one embodiment for block 810 may then output suitable transitional touch input data corresponding to a location over the boundary portion of surface 121 when detected touch input is identified over the boundary portion of surface 111 in anticipation that detected touch input will traverse to over surface 121.

Touch control logic 414 for one embodiment may similarly treat at least a portion of the boundary portion of surface 121 as part of touch-sensitive display device 110 when detected touch input traverses from over surface 121 outside the boundary portion of surface 121 to over the boundary portion of surface 111. Touch control logic 414 for one embodiment for block 810 may then output suitable transitional touch input data corresponding to a location over the boundary portion of surface 111 when detected touch input is identified over the boundary portion of surface 121 in anticipation that detected touch input will traverse to over surface 111.

As touch input for the operation continues to be detected for blocks 806 and 812, the operation may continue to be performed until block 816. Although described as having parts of the operation performed for blocks 804 and 814 as touch input is detected for blocks 806 and 812, respectively, the operation for one embodiment may not be performed until touch input is not detected for block 808.

For one embodiment, some additional detected touch input, such as a tap for example, may be used to end the operation for block 816. If a predetermined amount of time passes without such additional detected touch input, the operation for one embodiment may be undone if partially performed or may not be performed.

Operations for blocks 802-816 may be performed in any suitable order and may overlap in time with any other suitable operation. As one example, identifying detected touch input for block 808 may be performed prior to, or may overlap in time with, identifying detected touch input for block 806.

Use of Additional Touch Sensor

Touch controller 410 for one embodiment may use an additional touch sensor generally positioned between surfaces 111 and 121 to identify when detected touch input may traverse over a gap between surfaces 111 and 121.

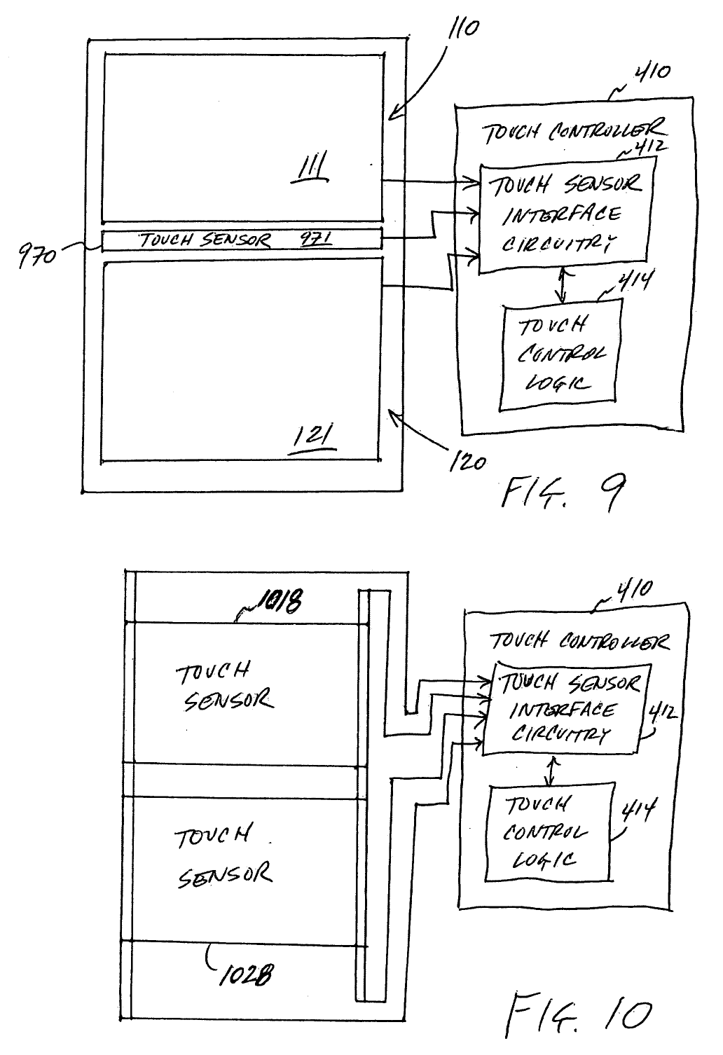

As illustrated in FIG. 9, electronic device 100 for one embodiment may have a touch sensor 970 distinct from touch-sensitive display devices 110 and 120. Touch sensor 970 has a surface 971 over which touch may be detected. Touch sensor 970 for one embodiment may include a touch-sensitive pad using any suitable technology such as, for example and without limitation, capacitive touch-sensitive technology or resistive touch-sensitive technology.

Touch sensor 970 may have any suitable size and shape and for one embodiment may generally lie between surface 111 for touch-sensitive display device 110 and surface 121 for touch-sensitive display device 120 along most or substantially all direct paths for touch input between surfaces 111 and 121. For one embodiment, touch sensor 970 may be positioned, sized, and shaped in any suitable manner to help provide a relatively more contiguous surface level between touch-sensitive display devices 110 and 120.

Touch sensor interface circuitry 412 for one embodiment may be coupled to detect touch input over surface 971 for touch sensor 970. Detected touch input having a path that traverses over surface 111, over surface 971, and over surface 121 may be identified, and an operation across touch-sensitive display devices 110 and 120 may be performed based at least in part on such identification. For one embodiment, as illustrated in FIG. 4, system control logic 430 and/or at least one processor 420 may interface with touch controller 410 to identify in any suitable manner detected touch input as having such a path and may interface with displays of touch-sensitive display devices 110 and 120 to perform in any suitable manner any suitable operation across touch-sensitive display devices 110 and 120 based at least in part on such detected touch input.

For one embodiment, touch controller 410 may help at least one processor 420 executing software to identify detected touch input having a path that traverses over surfaces 111, 971, and 121 by identifying when detected touch input traverses over surface 971 and outputting any suitable transitional touch input data in response to such identification. In this manner, touch controller 410 may treat touch input detected over surface 121 as being continued from touch input detected over surface 111 and may treat touch input detected over surface 111 as being continued from touch input detected over surface 121.

Touch sensor 970 for one embodiment may be used similarly as a boundary portion that does not overlap any display for both surfaces 111 and 121 as described above. Accordingly, example flow diagram 800 of FIG. 8 may similarly apply to use of touch sensor 970.

Although illustrated as having one touch sensor 970, electronic device 100 for one embodiment may have more than one touch sensor generally positioned between surfaces 111 and 121 in any suitable arrangement to identify when detected touch input may traverse over a gap between surfaces 111 and 121. Touch sensor interface circuitry 412 for one embodiment may be coupled to detect touch input over a surface for such touch sensors. Detected touch input having a path that traverses over surface 111, over a surface for at least one of such touch sensors, and over surface 121 may be identified, and an operation across touch-sensitive display devices 110 and 120 may be performed based at least in part on such identification.

Alternative Logic

Although one or more embodiments are described in connection with using touch controller 410 to treat touch input detected over surface 121 as being continued from touch input detected over surface 111 and/or to treat touch input detected over surface 111 as being continued from touch input detected over surface 121, other suitable logic may also be used.

For one embodiment, electronic device 100 may comprise any suitable logic to receive touch input data output from touch controller 410 and to identify in any suitable manner from such touch input data when detected touch input may traverse over a gap between surfaces 111 and 121. Such logic for one embodiment may identify from received touch input data detected touch input near or at a boundary of a display for touch-sensitive display device 110 or 120 to identify that detected touch input may traverse over the gap. Such logic for one embodiment may identify from received touch input data detected touch input that has traversed beyond the boundary of the display for touch-sensitive display device 110 or 120 to identify that detected touch input may traverse over the gap. Such logic for one embodiment may treat received touch input data that follows a lapse due to an identified touch input traversal over the gap as being continued from received touch input data that preceded the lapse. Such logic may be implemented in any suitable manner including use of any suitable hardware, firmware, and/or software logic.

For one embodiment, as illustrated in FIG. 4, at least one processor 420 executing software to process digital touch input data from touch controller 410 may execute any suitable additional software to identify when detected touch input may traverse over a gap between surfaces 111 and 121 and to treat received touch input data that follows a lapse due to an identified touch input traversal over the gap as being continued from received touch input data that preceded the lapse.

Series-Coupled Touch Sensors

Touch-sensitive display devices 110 and 120 for one embodiment may have touch sensors coupled in series. For one embodiment, this may help facilitate the treatment of such touch sensors by touch controller 410 as a single, larger touch sensor.

FIG. 10 illustrates, for one embodiment, a touch sensor 1018 for touch-sensitive display device 110 and a touch sensor 1028 for touch-sensitive display device 120. As illustrated in FIG. 10, touch sensors 1018 and 1028 may be coupled in series, and touch sensor interface circuitry 412 may be coupled to detect touch input from both touch sensors 1018 and 1028. Touch sensors 1018 and 1028 for one embodiment may each be implemented using any suitable touch sensor technology that defines a matrix of rows and columns and allows touch sensors 1018 and 1028 to be coupled in series to form a larger matrix. Touch sensors 1018 and 1028 for one embodiment may be implemented as capacitive touch screens.

For one embodiment, touch control logic 414 of touch controller 410 and/or at least one processor 420 executing software to process digital touch input data may treat touch input detected using touch sensor 1018 as being continued from touch input detected using touch sensor 1028 and/or may treat touch input detected using touch sensor 1028 as being continued from touch input detected using touch sensor 1018.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
a first touch-sensitive display device having a surface;
a second touch-sensitive display device having a surface;
touch sensor interface circuitry to detect touch input over the surface for the first touch-sensitive display device and over the surface for the second touch-sensitive display device; and
logic to perform an operation across the first and second touch-sensitive display devices based at least in part on detected touch input having a path that traverses over the surface for the first touch-sensitive display device and over the surface for the second touch-sensitive display device.

2. The apparatus of claim 1, wherein the logic includes touch control logic of a touch controller, the touch control logic to treat touch input detected over the surface for the second touch-sensitive display device as being continued from touch input detected over the surface for the first touch-sensitive display device.

3. The apparatus of claim 2, wherein the touch control logic is to output transitional touch input data when detected touch input traverses a gap between the surface for the first touch-sensitive display device and the surface for the second touch-sensitive display device.

4. The apparatus of claim 1, wherein the first touch-sensitive display device has a display; and
wherein the logic includes logic to identify detected touch input near or at a boundary of the display or that has traversed beyond the boundary of the display.

5. The apparatus of claim 1, wherein the first touch-sensitive display device has a display;
wherein the surface for the first touch-sensitive display device has a boundary portion that does not overlap the display; and
wherein the logic includes logic to identify detected touch input over the boundary portion.

6. The apparatus of claim 1, wherein the surface for the first touch-sensitive display device has a boundary portion; and
wherein the logic includes logic to identify detected touch input over the boundary portion to identify that detected touch input may traverse to over the surface for the second touch-sensitive display device.

7. The apparatus of claim 6, wherein the first touch-sensitive display device has a display, and
wherein at least a portion of the boundary portion overlaps the display.

8. The apparatus of claim 1, comprising at least one touch sensor having a surface;
wherein the touch sensor interface circuitry is to detect touch input over the surface for the at least one touch sensor; and
wherein the logic is to perform the operation across the first and second touch-sensitive display devices based at least in part on detected touch input having a path that traverses over the surface for the first touch-sensitive display device, over the surface for at least one of the at least one touch sensor, and over the surface for the second touch-sensitive display device.

9. The apparatus of claim 8, wherein the at least one touch sensor includes a touch-sensitive pad.

10. The apparatus of claim 1, wherein the first touch-sensitive display device includes a first touch sensor and the second touch-sensitive display device includes a second touch sensor; and
wherein the first touch sensor and the second touch sensor are coupled in series.

11. The apparatus of claim 1, comprising housing structure to support the first and second touch-sensitive display devices, the housing structure defining an axis about which the first and second touch-sensitive display devices may be at least partially rotated.

12. A method comprising:
detecting touch input over a surface for a first touch-sensitive display device and over a surface for a second touch-sensitive display device;
identifying detected touch input having a path that traverses over the surface for the first touch-sensitive display device and over the surface for the second touch-sensitive display device; and
performing an operation across the first and second touch-sensitive display devices based at least in part on the identification.

13. The method of claim 12, wherein the identifying includes treating by a touch controller touch input detected over the surface for the second touch-sensitive display device as being continued from touch input detected over the surface for the first touch-sensitive display device.

14. The method of claim 13, wherein the treating includes outputting by the touch controller transitional touch input data when detected touch input traverses a gap between the surface for the first touch-sensitive display device and the surface for the second touch-sensitive display device.

15. The method of claim 12, wherein the identifying includes identifying detected touch input near or at a boundary of a display for the first touch-sensitive display device or that has traversed beyond the boundary of the display.

16. The method of claim 12, wherein the identifying includes identifying detected touch input over a boundary portion of the surface for the first touch-sensitive display device, wherein the boundary portion does not overlap a display for the first touch-sensitive display device.

17. The method of claim 12, wherein the identifying includes identifying detected touch input over a boundary portion of the surface for the first touch-sensitive display device to identify that detected touch input may traverse to over the surface for the second touch-sensitive display device.

18. The method of claim 17, wherein at least a portion of the boundary portion overlaps a display for the first touch-sensitive display device.

19. The method of claim 12, wherein the detecting includes detecting touch input over a surface for at least one touch sensor; and
wherein the identifying includes identifying detected touch input having a path that traverses over the surface for the first touch-sensitive display device, over the surface for at least one of the at least one touch sensor, and over the surface for the second touch-sensitive display device.

20. An apparatus comprising:
a first touch-sensitive display device including a display and having a first surface, wherein the first surface has a boundary portion at least a portion of which does not overlap the display;
a second touch-sensitive display device having a second surface;
touch sensor interface circuitry to detect touch input over the first surface for the first touch-sensitive display device and over the second surface for the second touch-sensitive display device; and
logic to identify detected touch input having a path that traverses over a portion of the first surface outside the boundary portion, over the boundary portion, and over the second surface.

21. The apparatus of claim 20, wherein the logic includes touch control logic of a touch controller, the touch control logic to treat touch input detected over the surface for the second touch-sensitive display device as being continued from touch input detected over the surface for the first touch-sensitive display device.

22. The apparatus of claim 20, comprising housing structure to support the first and second touch-sensitive display devices, the housing structure defining an axis about which the first and second touch-sensitive display devices may be at least partially rotated.

23. An apparatus comprising:
a first touch-sensitive display device having a surface;
at least one touch sensor having a surface;
a second touch-sensitive display device having a surface;
touch sensor interface circuitry to detect touch input over the surface for the first touch-sensitive display device, over the surface for the at least one touch sensor, and over the surface for the second touch-sensitive display device; and
logic to identify detected touch input having a path that traverses over the surface for the first touch-sensitive display device, over the surface for at least one of the at least one touch sensor, and over the surface for the second touch-sensitive display device.

24. The apparatus of claim 23, wherein the at least one touch sensor includes a touch-sensitive pad.

25. The apparatus of claim 23, comprising housing structure to support the first and second touch-sensitive display devices, the housing structure defining an axis about which the first and second touch-sensitive display devices may be at least partially rotated.
